(19) United States
(12) Patent Application Publication
(10) Pub. No.: US 2002/0074524 A1
(43) Pub. Date: Jun. 20, 2002

(54) Magnetically shielded electromagnetic lens assemblies for charged-particle-beam microlithography systems

(75) Inventor: Katsushi Nakano, Kumagaya-shi (JP)

Correspondence Address: KLARQUIST SPARKMAN, LLP, Suite 1600, One world Trade Center, 121 S.W. Salmon Street, Portland, OR, 97204-2988, US

(73) Assignee: Nikon Corporation

(21) Appl. No.: 09/997,840

(22) Filed: Nov. 29, 2001

(30) Foreign Application Priority Data
Dec. 8, 2000 (JP) 2000-373818

(51) Int. Cl. H01J 3/00

(52) U.S. Cl. 250/505.1

(57) ABSTRACT

Electromagnetic lenses are disclosed that include a magnetic-shield body that is easy to manufacture and that exhibits stable performance, including with respect to temperature. In an embodiment a thin magnetic-shield body sheet is adhered to a non-magnetic cylindrical body situated radially between an electromagnetic lens and an associated deflector. The non-magnetic body desirably is made of ceramic. Magnetic flux from the ac magnetic field generated by the deflector diverges, with an accompanying decrease in the magnetic field density. Because the thin magnetic-shield body sheet is not saturated by such a magnetic field, nearly all the ac magnetic flux enters it rather than reaching the electromagnetic lens, and sufficient shielding is obtained.

### FIELD

This disclosure pertains to microlithography, which is a key technique used in the manufacture of microelectronic devices such as integrated circuits, displays, thin-film magnetic pickup heads, and micromachines. Microlithography generally involves the imaging of a pattern, usually defined by a reticle or mask, onto a surface of a substrate having a layer (termed a “resist”) imprintable with the image in a manner similar to photography. More specifically, this disclosure pertains to microlithography performed using a charged particle beam as an energy beam, instead of a beam of ultraviolet light as used currently in optical microlithography. Even more specifically, the disclosure pertains to magnetically shielded electromagnetic lenses as used in charged-particle-beam (CPB) optical systems and CPB microlithography systems incorporating the same.

### BACKGROUND

With the progressive miniaturization of active and passive circuit elements in modern microelectronic devices, the resolution limitations of optical microlithography have become more and more apparent. Hence, substantial research and development effort currently is being directed to development of a practical “next generation” microlithography technology. One approach under active development is microlithography performed using a charged particle beam such as an electron beam or ion beam. Charged-particle-beam (CPB) microlithography offers prospects of substantially greater resolution than optical microlithography for reasons similar to the reasons for which electron-microscopy provides substantially greater image resolution than optical microscopy.

Several types of CPB microlithography systems are under current development. An especially favored system is termed “divided reticle” CPB microlithography, in which the pattern-defining reticle is divided into multiple exposure units termed “subfields” each dimensioned about 1-mm square. Each subfield defines a respective portion of the pattern defined on the reticle. The subfields are exposed one at a time in sequential order, while moving both the reticle and the lithographic substrate (usually a semiconductor wafer), until transfer-exposure of the reticle pattern is complete. Typically, multiple microelectronic devices can be formed on a single substrate (each device formed on the substrate is termed a “die”), wherein the substrate is exposed multiple times in respective locations (i.e., respective dies) with the reticle pattern to form the pattern at each die on the substrate. In this regard, reference is made to U.S. Pat. No. 5,747,819, incorporated herein by reference.

During exposure of the reticle pattern on a die, successive illumination of each subfield is performed by laterally deflecting the charged particle beam as required to expose each subfield. Beam deflection typically is achieved using electromagnetic deflectors. Meanwhile, as the beam is being deflected, electromagnetic lenses are employed to shape and converge the beam as required. The electromagnetic lenses typically are coaxially disposed (along an “optical axis”) relative to each other so as to reduce distortions and other aberrations while the beam is being deflected. Also, at least one electromagnetic lens of a CPB optical system typically includes at least one respective electromagnetic deflector associated therewith (usually in a concentric relationship to the electromagnetic lens, wherein the respective deflector is situated radially inwardly of the corresponding electromagnetic lens). The electromagnetic deflector is configured to produce a “beam-deflecting” magnetic field oriented so as to laterally deflect the beam as required as the beam propagates through the respective electromagnetic lens.

An electromagnetic deflector must deflect the beam very quickly and rapidly. Energization of such a deflector at high frequency causes the deflector to produce a corresponding high-frequency ac magnetic field. An electromagnetic lens usually includes a conductive-wire (e.g., copper) winding and associated “pole piece” that, when electrically energized, generates the magnetic field of the lens. Without appropriate shielding, the ac magnetic field generated by the deflector tends to interact with, for example, the pole piece and produce an electrical eddy current. The eddy current, in turn, generates its own magnetic field that perturbs the beam-deflecting magnetic field. Such perturbations prevent the beam-deflecting magnetic field from stabilizing as rapidly as desired.

Reference is made to U.S. Pat. No. 4,376,249, in which a proposed approach for avoiding this phenomenon involves inserting a ferrite stack, consisting of an axially oriented “stack” of ring-shaped ferrite members with interspersed ring-shaped insulative members therebetween, between the electromagnetic deflector and the respective electromagnetic lens. This scheme is depicted in FIG. 8(a), showing an electromagnetic lens assembly 21 in which a ferrite stack 25 is situated between the electromagnetic deflector 23 and the respective electromagnetic lens 24. The ferrite stack 25 shields the ac magnetic field, produced by the deflector 23, from the lens 24. The deflector 23 has a cylindrical configuration and is disposed so as to surround a “beam tube” 22 in a radial manner. The electromagnetic lens 24 also has a generally cylindrical configuration and comprises a coil winding 26 and a respective pole piece 27 disposed radially outside the coil winding 26. The lens assembly 21 also includes a cylindrical ferrite stack 25, comprising alternately stacked units 28 of ferrite and insulating bodies 29 made of a non-magnetic material, situated between the deflector 23 and the lens 24. The respective axes of the deflector 23, the lens 24, and the ferrite stack 25 all coincide with the central axis Ax of the beam tube 22. The axis Ax is the optical axis of the lens assembly 21.

FIG. 8(b) is an oblique view showing the effect of the ferrite stack 25. FIG. 8(b) schematically depicts respective constituent coils 23a, 23b of the electromagnetic deflector 23, with the ferrite stack 25 being situated radially outside the coils 23a, 23b. (For clarity the ferrite stack 25 is depicted as a transparent cylinder, and only two typical coils 23a, 23b of the deflector 23 are shown.) The deflector 23 is a toroidal type of deflector, meaning that each constituent coil has a toroidal configuration.

The coils 23a, 23b are disposed so as to be rotationally symmetrical relative to each other. Normally, at any particular instant, the respective excitation currents flow in respective reverse directions in the coils 23a, 23b. An exemplary ac magnetic flux generated by the excitation current can be denoted by lines of force extending as indicated by the arrows 30 in FIG. 8(b). Some of this magnetic flux extends laterally across the optical axis Ax, which produces a corresponding magnetic field extending parallel to the optical axis Ax is produced and serving as the beam-deflecting magnetic field.

Meanwhile, other portions of the ac magnetic flux 30 produced by the coils 23a, 23b circulate around to outside the coils 23a, 23b. These “outer” portions of the magnetic flux enter the surrounding ferrite stack 25. The high magnetic permeability of the ferrite stack 25 prevents most of these outer portions of the ac magnetic field from penetrating to outside the ferrite stack 25. Ferrite also has a high electrical resistance, which inhibits formation of eddy currents by the ac magnetic field. As a result, perturbation of the deflection magnetic field is inhibited and the deflection magnetic field is stabilized.

Despite the benefits of a ferrite stack as summarized above, a ferrite stack has three principal disadvantages. First, a ferrite stack is difficult to manufacture. This is mainly because the ferrite stack is formed from multiple units (rings) of ferrite that must be individually produced and assembled with very low dimensional and manufacturing tolerances. Because the ferrite stack is instrumental in determining the shape of the deflection magnetic field on the optical axis, if the dimensional and manufacturing tolerances are exceeded during fabrication of the ferrite stack, then the profile of the deflection magnetic field on the optical axis is uneven, which causes aberrations.

Second, the function of a ferrite stack is temperature-dependent. With changes in the temperature of the ferrite stack, a corresponding change is exhibited in the position of a laterally deflected beam. The Curie point of ferrite is close to 200° C., which is low compared to most metals. The magnetic permeability of a material (such as ferrite) approaches zero as the temperature of the material nears its Curie point. Because the Curie point of ferrite is low, if the operating temperature (normally near room temperature) changes, the magnetic permeability of ferrite also changes correspondingly.

As shown in FIG. 8(b), a portion of the magnetic flux produced by the deflector coils 23a, 23b enters the ferrite stack 25. That is, some of the magnetic flux passing transversely across the optical axis circles around outside the deflector coils to the rear. With an increase in the magnetic permeability of the ferrite stack 25, the amount of magnetic flux entering the ferrite stack 25 increases, as would be indicated by a corresponding increase in the number of lines of force 30 entering the ferrite stack 25. As a result, however, the deflection magnetic field at the optical axis Ax also decreases, resulting in the beam propagating along the axis being under-deflected by the deflector relative to specification.

Third, ferrite is made by mixing multiple constituent materials in a powdery state before sintering them together into a rigid mass. During the powder-mixing step, non-uniformities of mixture likely occur (and persist during the subsequent sintering step), causing substantial random variations in the homogeneity of the product. Also, magnetic characteristics of ferrite are dictated by (and are subject to variations in) sintering conditions, which also cause random variations in the product.

### SUMMARY

In view of the shortcomings of the prior art as summarized above, the present invention provides, inter alia, electromagnetic lenses that include a magnetic shield member that is easy to manufacture and that exhibits stable performance with respect to both manufacturing conditions and temperature. Another object is to provide charged-particle-beam (CPB) optical systems and CPB microlithography systems that include one or more such lenses.

According to a first aspect of the invention, electromagnetic lenses are provided for use in a charged-particle-beam exposure apparatus. An embodiment of such a lens comprises, along an optical axis, a lens coil winding, a pole piece, at least one electromagnetic deflector, and a magnetic-shield body. The pole piece is associated with (usually situated concentrically with) the coil winding. The at least one electromagnetic deflector is situated concentrically with the coil winding and the pole piece. The magnetic-shield body is situated concentrically with the deflector, coil winding, and pole piece, and is configured as a magnetic metal foil situated between the deflector and the coil winding. The electromagnetic deflector can be any of various deflectors, correctors, and dynamic focus coils.

The magnetic-shield body, configured as a magnetic metal foil, replaces the ferrite stack used in conventional electromagnetic lenses. By configuring the magnetic-shield body as having a foil-like property, the body can be custom-sized and mounted (relative to the lens and deflector) wherever needed for blocking magnetic fields. The foil is typically extremely thin; a representative foil thickness is about 10 μm, which renders the foil highly resistant to the flow of eddy currents in the foil. Thus, because eddy-current loss in the presence of an alternating-current (ac) magnetic field is substantially reduced compared to conventional electromagnetic lenses, the present electromagnetic lenses are effectively shielded against ac magnetic fields produced by the deflector. The magnetic-shield body also is an effective shield against penetration by direct-current (dc) magnetic fields. Also, since eddy currents are substantially reduced, the conventional phenomenon of eddy currents interfering with the stabilization of deflection magnetic fields is prevented.

The thinness of the magnetic-shield body ensures that it easily saturates with the dc magnetic flux created by the electromagnetic lens. As a result, almost none of the dc magnetic field enters or passes through the magnetic-shield body. Also, the ac magnetic flux created by the deflector does not saturate the magnetic-shield body, allowing almost all of the ac magnetic field to enter the shield body. Because the magnetic-shield body is thin, it can be formed and attached (e.g., using an adhesive) readily to an outer cylindrical surface of a non-magnetic and electrically non-conductive (e.g., ceramic) body disposed between the magnetic-shield body and the deflector. This is much easier to perform than stacking multiple ferrite rings. Also, the magnetic-shield body typically has a Curie point of about 800° C., which is much higher than of ferrite. As a result, if the normal operating temperature of the magnetic-shield body experiences a change during use, the resulting change in magnetic permeability of the body (with consequential beam shifting) is extremely small compared to what would be experienced using a ferrite stack. Finally, forming a foil eliminates any need to mix and sinter powdered materials, thereby providing a more uniform product and greater stability of the product of the process.

Thus, the magnetic-shield body solves the three problems, as noted earlier above, conventionally experienced with ferrite stacks, and also provides superior shielding performance compared to a ferrite stack.

By forming the foil on the external cylindrical surface of a non-magnetic and electrically non-conductive body, the magnetic-shield body is more easily provided with a desired rotational symmetry that eliminates non-uniformity of shielding effect. Furthermore, a non-magnetic and electrically non-conductive body is relatively easy to machine or otherwise provide with a cylindrical outer surface with high accuracy and precision. By adhering or otherwise attaching the magnetic-shield body to the cylindrical outer surface, the shape and dimensions of the magnetic-shield body can be configured with high accuracy. Meanwhile, the non-magnetic and electrically non-conductive material is unaffected by magnetic fields, so the desired magnetic-shielding effect is provided by the magnetic-shield body whether or not the non-magnetic body is present. Also, being electrically non-conductive, the non-magnetic body exhibits minimal eddy currents.

If the magnetic-shielding effect of a single layer of the magnetic-shield body (formed as a single layer around the non-magnetic body) is insufficient, then the magnetic-shield body can be wrapped multiple times around the non-magnetic body to form a multilayer magnetic-shield body (with intervening layers of a thin insulating material). Thus, the magnetic-shielding effect is increased while preventing any corresponding increase in eddy currents.

The pole piece of the electromagnetic lens generally includes a first axial end and a second axial end. The non-magnetic body can be disposed so as to engage at least one of the axial ends of the pole piece. Thus, the non-magnetic body can be supported by the pole piece, which eliminates the need for other means for supporting the body while still providing an accurate positional relationship of the electromagnetic lens and magnetic-shield body.

Conventionally, the magnetic field created by the electromagnetic lens concentrates at the axial ends of the pole piece. Consequently, a magnetic-shield body located near the axial ends usually is close to magnetic saturation, with a corresponding reduction in the differential magnetic permeability of the magnetic-shield body. An ac magnetic flux (created by the deflector) having an influence in the area occupied by the axial ends of the pole piece would ordinarily cause the magnetic-shield body in this area to behave as if it had a low apparent magnetic permeability. The corresponding decrease in the magnetic-shielding effect would allow the magnetic field created by the deflector to penetrate through the magnetic-shield body to the axial ends of the pole piece where eddy currents would be generated. These eddy currents would lengthen the time required to stabilize the magnetic field created by the deflector.

Hence, at least one of the first and second axial ends of the pole piece can comprise ferrite, which increases the electrical resistance of the axial end and decreases the eddy currents in the pole piece. Such a configuration prevents a lengthening of the time for stabilizing the magnetic field created by the deflector. It is not necessary that the entire axial end(s) of a pole piece comprise ferrite. Rather, only the region of an axial end closest to the optical axis can be made of ferrite, leaving the rest of the axial end made of steel, for example. Such a configuration is advantageous if the axial end is used for supporting any substantial mass of the magnetic-shield body and non-magnetic body. Taking into account the strength of the axial end(s) and the mass to be supported thereby, a person of ordinary skill in the relevant art will be able readily to determine the extent of the axial end(s) to form of ferrite.

At least a respective portion of each of the first and second axial ends can be made of ferrite, wherein the non-magnetic body is situated, along the optical axis, between the first and second axial ends. By supporting the non-magnetic body on both axial ends by the respective ferrite portions, no other support of the body is necessary and the position of the magnetic-shield body can be established and maintained with high accuracy.

The magnetic-shield body can be situated, along the optical axis, between the first and second axial ends of the pole piece, with respective gaps between the magnetic-shield body and the first and second axial ends. The gaps increase the magnetic resistance in the respective regions of the gaps, thereby minimizing passage of magnetic flux created by the electromagnetic lens inside the magnetic-shield body. As a result, more of the magnetic field created by the lens can be used for the desired lens effect, thereby increasing the efficiency of the electromagnetic lens.

The magnetic-shield body can comprise multiple portions separated from each other along the optical axis. I.e., in this configuration, the magnetic-shield body is divided in the axial direction into multiple portions (with intervening gaps therebetween). The magnetic resistance of the shield body is increased in the intervening gaps, thereby minimizing passage of magnetic flux, inside the magnetic-shield body, created by the electromagnetic lens. As a result, more of the magnetic field created by the lens can be used for the desired lens effect, thereby increasing the efficiency of the electromagnetic lens.

According to another aspect of the invention, methods are provided for manufacturing a magnetic-shield body for use in an electromagnetic lens. In an embodiment of such a method, a non-magnetic and electrically non-conductive body is prepared so as to have a cylindrical outer surface extending along an axis. Multiple magnetic-shield body sheets are attached circumferentially to the cylindrical outer surface. Each body sheet has a sheet width, in an axial direction, that is wider than a specified sheet width. The individual body sheets are separated from each other, in the axial direction, on the cylindrical outer surface by respective gaps that are narrower than a specified gap width. Material along one or more circumferential edges of each respective magnetic-shield body sheet is removed so as to widen the respective gaps to the specified gap width while narrowing each body sheet, in the axial direction, to the specified sheet width.

The foregoing and additional features and advantages of the invention will be more readily apparent from the following detailed description, which proceeds with reference to the accompanying drawings.

### BRIEF DESCRIPTION OF THE DRAWINGS

FIG. 1(a) is an elevational section of an electromagnetic lens according to a first representative embodiment.

FIGS. 1(b)-1(c) each depict the elevational section shown in FIG. 1(a) along with lines of magnetic flux of a dc and an ac magnetic field, respectively, produced by the lens.

FIGS. 2(a)-2(c) are respective elevational sections of three embodiments of electromagnetic lens assemblies. Each elevational section passes through the respective optical axis.

FIG. 3(a) is an axial section of an electromagnetic lens according to another representative embodiment.

FIG. 3(b) is an oblique view of the embodiment of FIG. 3(a), showing the ac magnetic field produced by the deflector coils and eddy currents produced in a non-divided magnetic-shield body by the ac magnetic field.

FIG. 3(c) is an oblique view of the embodiment of FIG. 3(a), showing the ac magnetic field produced by the deflector coils and eddy currents produced in a transversely divided magnetic-shield body by the ac magnetic field.

FIGS. 4(a)-4(c) show results of respective steps in a method for manufacturing a magnetic-shield body such as used in the embodiment of FIG. 3(a).

FIG. 5 is a schematic elevational diagram of a CPB optical system (as used in, e.g., a charged-particle-beam microlithography system) including at least one electromagnetic lens according to an embodiment within the scope of the instant disclosure.

FIG. 6 is a process flow chart depicting certain steps in a microelectronic-device manufacturing method.

FIG. 7 is a process flow chart depicting certain steps in a microlithography step of the method shown in FIG. 6.

FIG. 8(a) is an elevational section of a conventional electromagnetic lens.

FIG. 8(b) is an oblique view of a portion of the of FIG. 8(a), showing lines of magnetic force denoting a magnetic flux produced by the deflector coils of the lens.

### DETAILED DESCRIPTION

The invention is described below in the context of representative embodiments that are not intended to be limiting in any way.

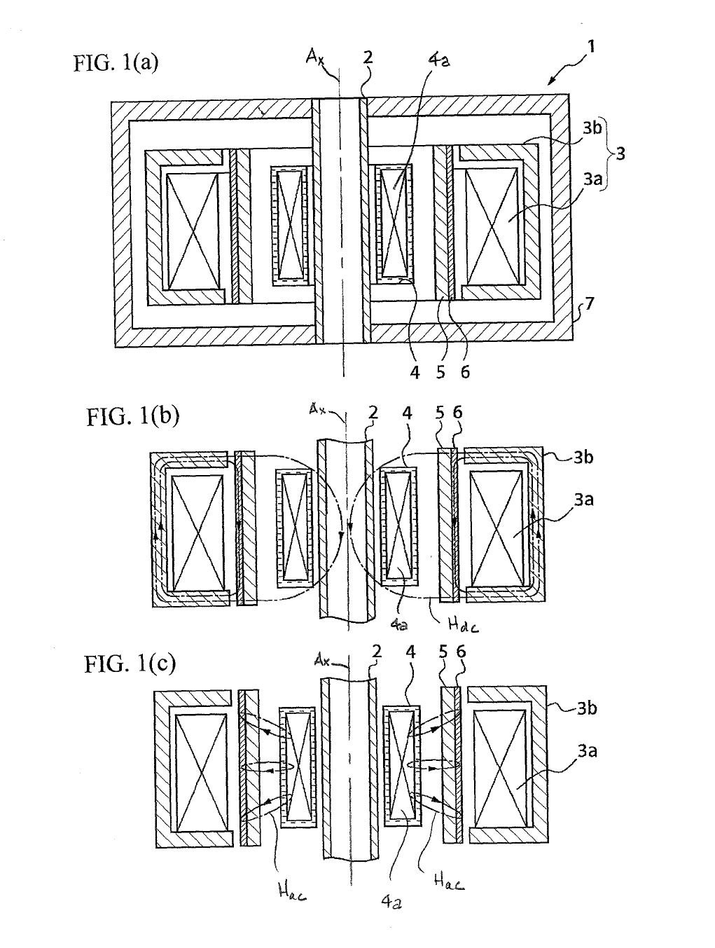

A first representative embodiment of an electromagnetic lens assembly is depicted in FIGS. 1(a)-1(c), to which reference now is made. FIG. 1(a) is an elevational section schematically depicting the subject electromagnetic lens assembly 1 as used in an electron-beam optical system (as a representative charged-particle-beam, or “CPB”, optical system). FIG. 1(b) depicts exemplary lines of force H_{dc} denoting a dc (direct current) magnetic field created by the electromagnetic lens 1 of FIG. 1(a), and FIG. 1(c) depicts exemplary lines of force H_{ac} denoting an ac (alternating current) magnetic field created by the deflector of the lens assembly 1.

The lens assembly 1 comprises a column (also termed a “beam tube” or “liner tube”) 2, an electromagnetic lens 3 including a coil winding 3a and a pole piece 3b, a “deflector” 4, a cylindrical non-magnetic body 5, a magnetic-shield body 6, and a lens housing 7. The term “electromagnetic lens” used in connection with item 3 is used in a narrow sense; the “electromagnetic lens” described in the claims and elsewhere in this disclosure generally includes the magnetic-shield body 6 in addition to the electromagnetic lens 3.

In FIG. 1(a), the column 2 serves as a vacuum partition inside the lens housing 7. The interior of the column 2 is maintained at a high vacuum to allow unobstructed propagation of the electron beam in a generally axial direction through the column 2. Although only one electromagnetic lens assembly 1 is shown in FIG. 1(a), it will be understood that multiple such electromagnetic lens assemblies typically are provided in an electron-optical system or CPB optical system in general, such as used in a CPB microlithography apparatus.

The electromagnetic lens 3 with its coil winding 3a and pole piece 3b, as well as the deflector 4, are concentric relative to the optical axis Ax. The “deflector” 4 in this embodiment is a toroidal type; however, the scope of the invention is not limited to use of toroidal deflectors. The “deflector” 4 can be any of various electromagnetic deflectors and analogous components such as (but not limited to) aberration-correctors, dynamic-focus coils, and stigmators.

Attention now is directed to the magnetic-shield body 6. Desirably, the magnetic-shield body 6 is attached (e.g., adhered) to the cylindrical non-magnetic body 5 and disposed between the electromagnetic lens 3 and the deflector 4. The body 5 is made of a rigid, inert, durable, non-magnetic, electrically insulative material such as ceramic. Due to the cylindrical configuration of the non-magnetic body 5, the magnetic-shield body 6 typically also is cylindrical and concentric with the non-magnetic body 5. Thus, having a cylindrical configuration, the magnetic-shield body 6 solves certain problems conventionally experienced with a ferrite stack, while also providing effective magnetic shielding. First, configuring the sheet-like magnetic-shield body as a cylinder is much easier than precisely stacking multiple rings of ferrite and insulative material. With the magnetic-shield body 6, attaining a highly accurate cylindrical configuration is achieved simply by adhering it to the cylindrical non-magnetic body 5. Second, the metal from which the magnetic-shield body 6 is made usually has a Curie point of about 500° C., which is high compared to ferrite. As a result, the magnetic-shield body 6 exhibits relatively low beam shift accompanying changes in temperature. Third, in contrast to the random variation in ferrite product uniformity (resulting from having to prepare a powder mixture that is sintered), the magnetic-shield body 6 exhibits greater stability than ferrite.

The magnetic-shield body 6 desirably is made of a thin, magnetic-metal foil such as Permalloy or other alloy comprising iron, nickel, and/or cobalt, or an amorphous material including one or more of these metals. The magnetic permeability of the magnetic-shield body 6 desirably is very high so as to provide good shielding against both ac and dc magnetic fields generated by the deflector 4.

The magnetic-shield body 6 desirably is very thin, typically much less than 1 mm. If the magnetic-shield body 6 had a thickness of about 1 mm or more, then an ac magnetic field to be shielded against would generate very large eddy currents in the magnetic-shield body 6, which would substantially perturb the magnetic field produced by the deflector 4. Hence, the magnetic-shield body 6 should be much thinner than 1 mm. Generally, the thinner the magnetic-shield body 6, the greater its electrical resistivity, which results in less eddy current and, consequently, less deflector-field perturbation. In view of these considerations, an exemplary range of thickness of the magnetic-shield body 6 is about 10 μm to about 30 μm, which provides a practical level of eddy-current suppression. The thickness should be reduced with higher-frequency ac magnetic fields because higher-frequency ac magnetic fields tend to generate more eddy currents. The thickness also should be reduced with lower electrical resistivity of the magnetic-shield body 6. (Electrical resistivity depends on the particular material of the magnetic-shield body 6 and the manner in which the material and body have been fabricated.) For the same reasons, the non-magnetic body 5 should be made of an electrical non-conductor to prevent formation therein of eddy currents that otherwise would perturb the deflector field.

The magnetic-shield body 6 should be thin, as described above, even if the respective magnitudes of the magnetic fields generated by the electromagnetic lens 3 and deflector 4 were low and the magnetic-shield body 6 were not saturated. If the magnetic-shield body 6 were thicker than as described above, then the magnetic flux extending from the pole piece 3b to the optical axis Ax would be shielded completely, which would prevent the magnetic flux from the electromagnetic lens 3 from reaching the optical axis (thus, no lens field would be generated at the optical axis). The magnetic-shield body 6 should be sufficiently thin to provide sufficient magnetic resistance between the “upper” end of the pole piece 3b and the “lower” end of the pole piece 3b to urged a desired portion of the lens flux to extend from the thin magnetic-shield body 6 to the optical axis Ax (see FIG. 1(b)). Also, because the magnetic-shield body 6 is arranged perpendicularly to the lens flux, the proportion of the lens field penetrating to the optical axis Ax is increased because of the continuous nature of magnetic flux.

An especially advantageous manner in which to attach the magnetic-shield body 6 to the non-magnetic body 5 is by an adhesive, wherein the non-magnetic body 5 physically supports the magnetic-shield body 6. The non-magnetic body 6 need not cover the entire outer surface of the non-magnetic body 5, but rather only those regions of the outer surface in which it is desirable to block a magnetic flux. The non-magnetic body 5 can be configured with a very accurate cylindrical profile (e.g., by surficial machining). The more accurately this surface is configured, the more accurately the magnetic-shield body 6 can be provided with its desired shape and dimensions. Since the non-magnetic body 5 is unaffected by magnetic fields, the same magnetic shielding effect is obtained with the magnetic-shield body 6 attached to the non-magnetic body 5 as otherwise would be achieved using the magnetic-shield body 6 alone.

The thinness of the magnetic-shield body 6 provides it with high electrical resistance and renders it resistant to the flow of eddy currents in it. Hence, eddy currents arising from the ac magnetic field of the deflector 4 are reduced in the magnetic-shield body 6 compared to in a ferrite stack. The reduced eddy currents yield a correspondingly reduced interference by eddy currents with stabilization of the deflection magnetic field. Hence, the magnetic-shield body 6 provides effective shielding against not only a dc magnetic field but also ac magnetic fields.

Exemplary magnetic lines of force of a dc magnetic field produced by the electromagnetic lens 3 are indicated by respective arrows H_{dc} shown in FIG. 1(b). The “upper” and “lower” ends of the pole piece 3b tend to be saturated with the dc magnetic flux. From the pole piece 3b, some of the lines of force enter and pass in the axial direction in the magnetic-shield body 6 and re-enter the pole piece 3b. However, because the magnetic-shield body 6 is very thin, most of the dc magnetic flux from the pole piece 3b circulates to the optical axis Ax and then back to the pole piece 3b.

Exemplary lines of force of the ac magnetic field formed by the deflector 4 are indicated by the arrows H_{ac} in FIG. 1(c). Magnetic flux from the deflector 4 enters the magnetic-shield body 6 as indicated by the elliptical arrows in the figure. The flux exits the magnetic-shield body 6 and re-enters the coil 4a of the deflector 4. This magnetic flux exiting the deflector 4 broadens somewhat, resulting in a decrease in the density of the magnetic field. Hence, the magnetic-shield body 6 does not become saturated with this ac magnetic field, even though nearly all the lines of force H_{ac} enter the magnetic-shield body 6. Because the ac magnetic field created by the deflector 4 enters the magnetic-shield body 6 and thus does not reach the electromagnetic lens 3, sufficient shielding of the lens from the ac magnetic field is obtained.

As is evident from the foregoing, the magnetic-shield body 6 desirably is sufficiently thin to be saturated by a portion of the dc magnetic field created by the electromagnetic lens 3 while not being saturated by the ac magnetic field created by the deflector 4. If it is desired to increase the magnetic-shielding effect of the magnetic-shield body 6, the magnetic-shield body 6 may be wound around the non-magnetic body 5 in a cylindrical manner multiple times to form two or more shield layers, with intervening layers of thin insulative material. For example, the insulative material can be formed as respective layers of an epoxy resin, which is applied to the magnetic-shield body 6 before winding. Thus, the layers of magnetic-shield body 6 are adhered together with a layer of cured epoxy resin between each layer to provide good electrical isolation between the layers for suppressing eddy currents. An exemplary thickness of each epoxy layer is about 50 μm. Although the effective thickness of the magnetic-shield body 6 would be increased using this multilayer scheme, the individual layers thereof nevertheless are very thin. Hence, increased eddy currents do not arise in such a multilayered magnetic-shield body 6.

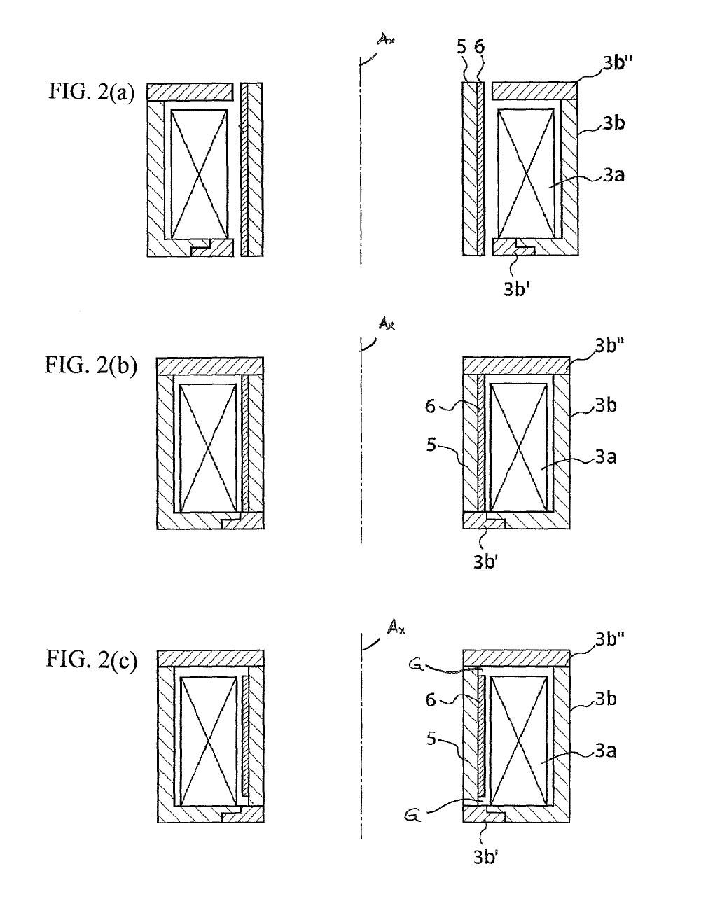

FIGS. 2(a)-2(c) depict respective exemplary embodiments of magnetic lenses. Each figure is an elevational section along a plane that intersects the optical axis Ax, with the column and deflector omitted for clarity. In FIGS. 2(a)-2(c), components similar to corresponding components shown in FIGS. 1(a)-1(c) have the same respective reference numerals and are not described further.

In FIG. 2(a) the pole piece 3b has an “upper” end 3b″ and a “lower” end 3b′ made of ferrite. As described above, the magnetic flux produced by the electromagnetic lens concentrates at the ends 3b′, 3b″ of the pole piece 3b. This concentration causes the thin magnetic-shield body 6 in these regions to be essentially magnetically saturated. Whenever magnetic saturation of the magnetic-shield body 6 occurs, the differential magnetic permeability of the saturated region has a value at or near unity (1). This causes the magnetic-shield body 6 in these regions to behave as a substance having a low apparent magnetic permeability, with a corresponding decrease in its performance as a magnetic shield in these regions. Under such conditions, the ac magnetic field created by the deflector penetrates the magnetic-shield body 6 to the pole piece 3b. As a result, the ends 3b′, 3b″ of the pole piece 3b are exposed to the ac magnetic field, which creates respective eddy currents at the ends 3b′, 3b″. Ordinarily, this would increase the time needed for stabilizing the magnetic field created by the deflector.

However, as noted above, in the embodiment of FIG. 2(a) the pole-piece ends 3b′, 3b″ are made of ferrite, which has a higher electrical resistance than the pole piece 3b. Consequently, eddy currents generated in these pole-piece ends due to the ac magnetic field are reduced, resulting in very little adverse effect of the eddy currents on the deflection magnetic field.

Because ferrite is easily fractured, the lens mass desirably is not supported by the ferrite pole-piece ends 3b′, 3b″. Also, the magnetic properties of ferrite change according to stress applied to the ferrite. Hence, the “lower” pole piece 3b′ desirably is made of ferrite only in regions near the optical axis Ax as shown; the outer portions of the “lower” pole piece 3b′ can be made of a conventional ferromagnetic material (e.g., mild steel). On the other hand, because no external forces normally act on the “upper” pole piece 3b″, it can be made entirely of ferrite. Alternatively, if desired, ferrite can be the material only of the radially inner portions of the “upper” pole piece 3b″ without any adverse consequences. Considerations of the extent to which ferrite is used, as well as strength considerations for the pole-piece ends can be made readily by a person skilled in the art.

FIG. 2(b) depicts an embodiment in which the magnetic-shield body 6 is attached (e.g., adhered) to the cylindrical non-magnetic body 5 and situated between the “upper” and “lower” pole pieces 3b′, 3b″. This configuration produces the same operational effects as the embodiment of FIG. 2(a). By supporting the cylindrical non-magnetic body 5 by the pole pieces 3b′, 3b″ in the manner shown in FIG. 2(b), the magnetic-shield body 6 is accurately disposed at a specified location relative to the electromagnetic lens 3 without having to provide a separate support means.

FIG. 2(c) depicts an embodiment in which respective gaps G are provided between the “upper” and “lower” edges of the magnetic-shield body 6 and the “upper” and “lower” pole pieces 3b′, 3b″, respectively. These gaps increase the resistance in the magnetic-flux circuit from the respective pole piece through the magnetic-shield body 6 and back to the respective pole piece. Thus, the magnetic field created by the electromagnetic lens and passing within the magnetic-shield body 6 is minimized. In other words, with respect to the magnetic field created by the electromagnetic lens 3, the magnetic field passing through a region including a gap G is reduced, which allows more of the magnetic field to operate in the region of the optical axis Ax. Hence, a desired lens field can be formed using less power than would be used in the configuration of FIG. 2(b).

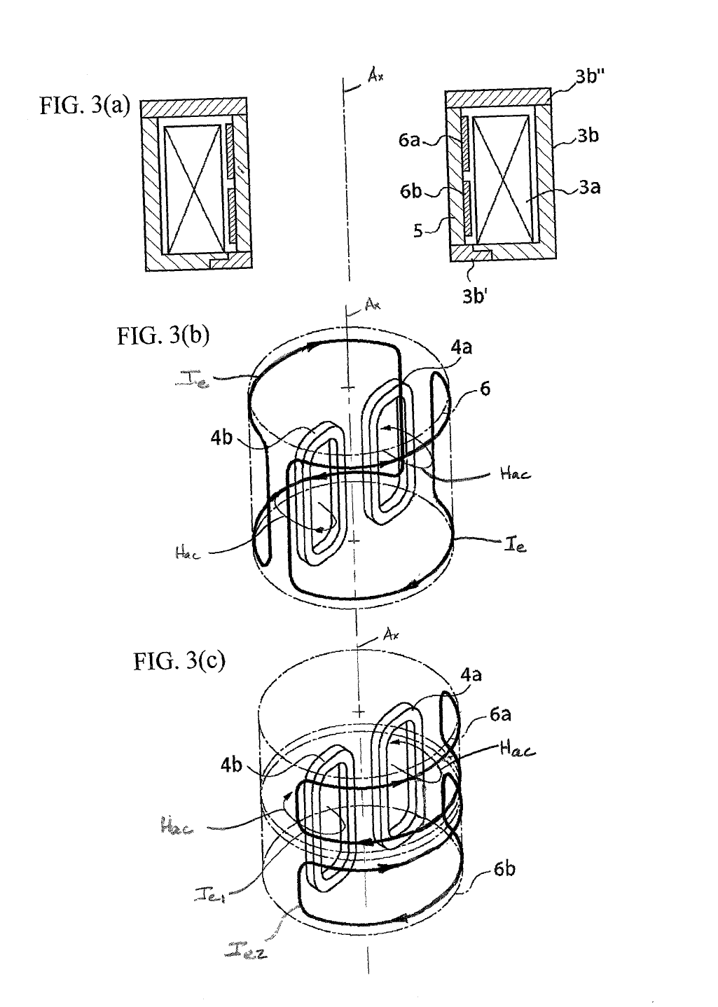

FIGS. 3(a)-3(c) depict another representative embodiment of an electromagnetic lens. FIG. 3(a) is an elevational section in a plane passing through the optical axis Ax, with the column and deflectors omitted for clarity. The basic construction shown in FIG. 3(a) is similar to that of the configuration shown in FIG. 2(c), except that in FIG. 3(a) the magnetic-shield body 6 is divided transversely into an “upper” portion 6a and a “lower” portion 6b. The divided magnetic-shield body 6 in this embodiment exhibits a greater resistance to the magnetic field created by the electromagnetic lens 3 compared to the embodiment of FIG. 2(c). The embodiment of FIG. 3(a) also allows a corresponding reduction of the magnitude of the magnetic field produced by the electromagnetic lens 3 without reducing the effect of the lens field in the region of the optical axis Ax. Thus, the power efficiency of the electromagnetic lens 3 is increased.

Since the division is perpendicular to the lens field, the flux of the lens field is prevented from passing through the magnetic-shield body 6. Consequently, more of the lens-field flux passes near the optical axis and thus increases the magnitude of the lens field at the optical axis. Since the division is parallel to the flux of the deflection field, the deflection flux is not prevented from entering the magnetic-shield body 6. In other words, dividing the magnetic-shield body 6 has an anisotropic effect. Division increases the magnetic resistance of the magnetic-shield body 6 in the axial direction and thus enhances the lens field at the optical axis Ax, but the magnetic resistance in the transverse direction is left largely intact, thereby allowing the deflection flux to flow smoothly in the magnetic-shield body.

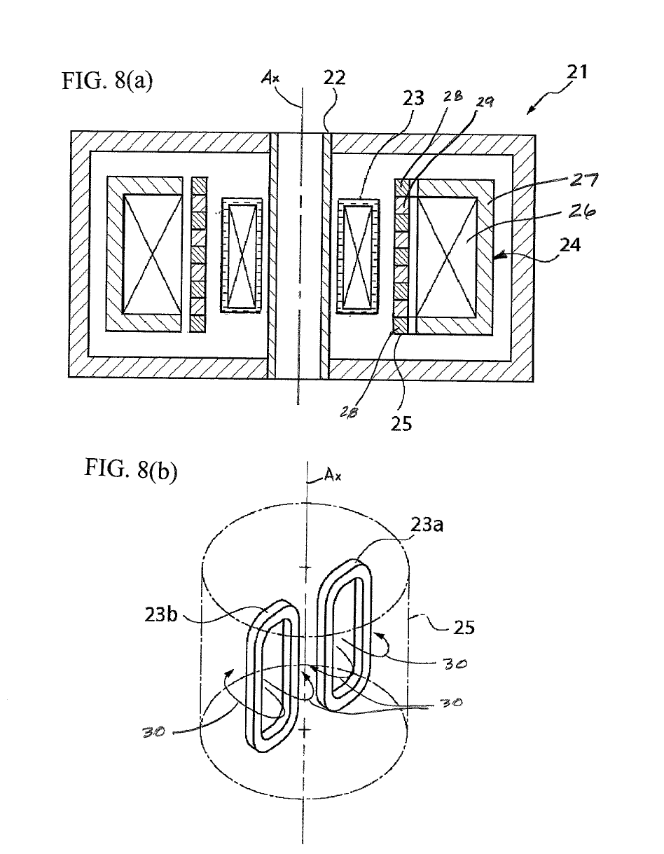

The embodiment of FIG. 3(a) also exhibits smaller eddy-current loops, which allows the stabilization times of the deflection magnetic field to be decreased, as discussed with reference to FIGS. 3(b) and 3(c). In FIGS. 3(b) and 3(c) two typical deflector coils 4a and 4b are shown. The perspectives of FIGS. 3(b) and 3(c) are similar to that of FIG. 8(b), wherein the cylindrical profiles of the magnetic-shield body 6 (FIG. 3(b)) and portions 6a, 6b thereof (FIG. 3(c)) are indicated as respective “transparent” cylinders.

The configuration of FIG. 3(b) corresponds to the magnetic lens of FIG. 2(c). The ac magnetic field produced by the deflector coils 4a, 4b is indicated by the fine arrows H_{ac}. This ac magnetic field H_{ac} creates eddy currents indicated by the thick arrows Iₑ “inside” the magnetic-shield body 6.

The configuration of FIG. 3(c) corresponds to that of FIG. 3(a). In FIG. 3(c) the ac magnetic field produced by the deflector coils 4a, 4b is indicated by the fine arrows H_{ac}. This ac magnetic field H_{ac} creates eddy currents indicated by the thick arrows I_{c1}, I_{c2} “inside” the magnetic-shield body portions 6a, 6b. For simplification, only half the eddy currents are shown. Since the magnetic-shield body 6 comprises two portions 6a, 6b in FIG. 3(c), each eddy current likewise is divided into two portions Iₑ₁, Iₑ₂. Each eddy current (or portion thereof) can be regarded as a respective inductor that behaves as if it has a respective coil winding. Dividing each eddy current Iₑ into constituent portions Iₑ₁, Iₑ₂ reduces the area of the respective inductor. By reducing the area of each respective inductor, the individual inductances of the respective inductors are correspondingly reduced, resulting in a faster response time of the deflector to the ac magnetic field.

Although the foregoing embodiments were described in the context of using an electron beam as an exemplary charged particle beam, it will be understood that the embodiments have similar utility in CPB optical systems employing an ion beam, which is another type of charged particle beam.

Although the foregoing embodiments were described in the context of blocking ac magnetic fields created by an electromagnetic deflector, the principles of these embodiments are not limited to use in association with electromagnetic deflectors. Any of various types of beam correctors (e.g., stigmators), focus coils, and the like that are operated dynamically (actively) also create ac magnetic fields. Hence, the principles described above are also effective for blocking these other ac magnetic fields.

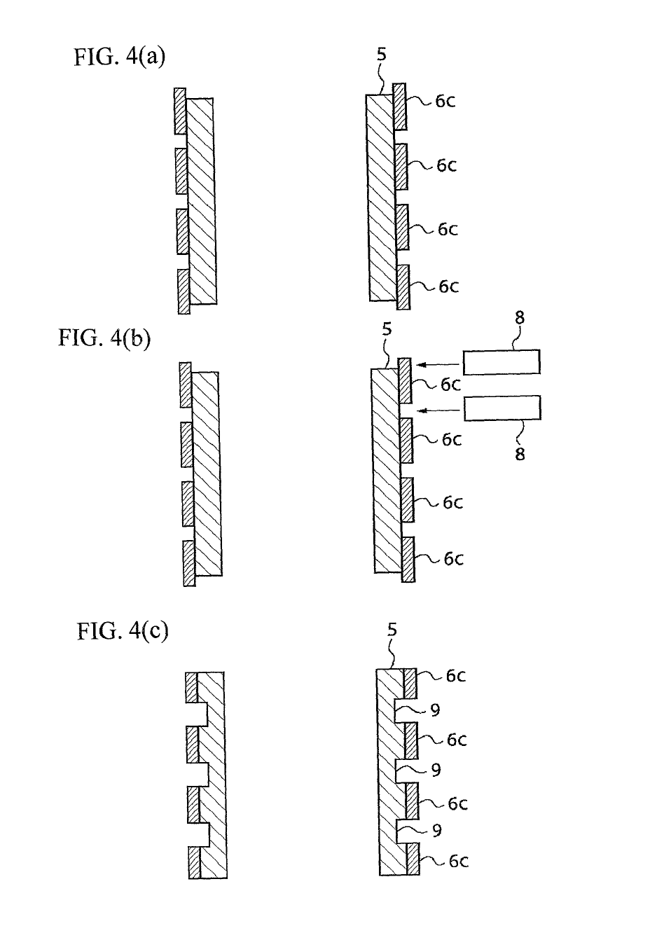

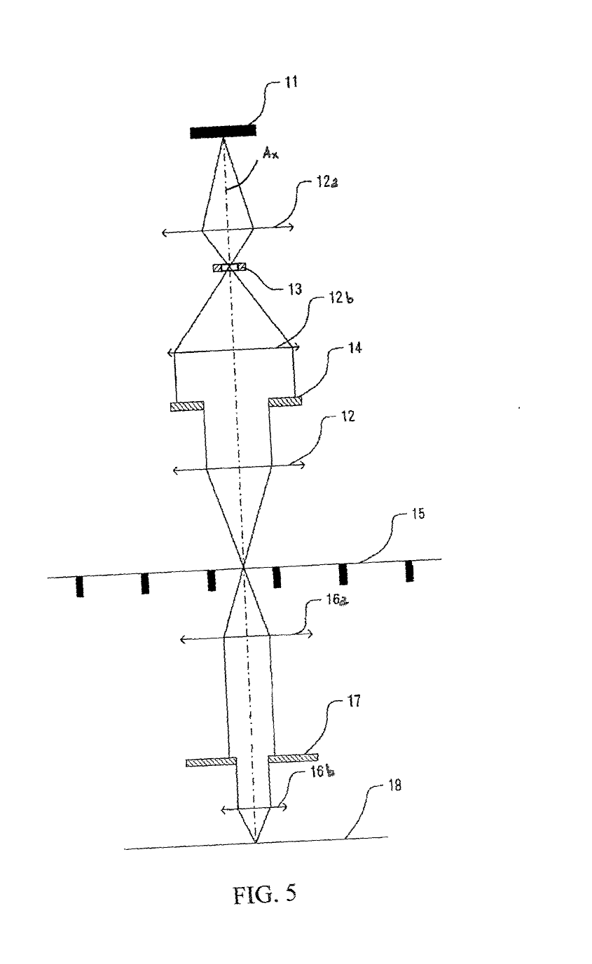

FIGS. 4(a)-4(c) depict a representative method for manufacturing the magnetic-shield body configured as shown in FIG. 3(a). With respect to this embodiment, it is noted that large units of magnetic-shield material are expensive and difficult to procure. However, a magnetic-shield material in “tape” form (having a width of about 50 mm, for example) is relatively inexpensive and easy to procure. In a first step, shown in FIG. 4(a), multiple units 6c of tape-like magnetic-shield material are adhered circumferentially to the outside of a cylindrical non-magnetic body 5, with a respective open space between each unit 6c. The respective width of each unit 6c need not be uniform, in view of the normal significant variation in tape width from unit 6c to unit 6c. Also, the respective ends of each tape-like unit 6c typically are not accurately aligned with each other due to errors in respective winding position. This embodiment solves these problems.

First, the cylindrical non-magnetic body 5 is made of a rigid material that can be mechanically processed (machined). The material is non-magnetic so as not to exhibit any magnetic effect on a charged particle beam propagating nearby. In other words, the material desirably is an “insulative” material in which eddy currents are not created. The non-magnetic body 5 is machined accurately to the desired cylindrical profile.

At the time of adhesion of the tape-like units 6c to the outside of the non-magnetic body 5, the width of each tape-like unit 6c typically is greater than the final desired width of the unit, and the axial width of the space between adjacent tape-like units 6c is narrower than the final desired width. I.e., the accuracy of the respective widths of the magnetic-shield units 6c and of the axial spaces between them may be “coarse” at the time of assembly of the units 6c to the non-magnetic body 5. Also, at each end of the non-magnetic body 5 the respective tape-like unit 6c is wound so as to project slightly from the end in the axial direction.

Next, as shown in FIG. 4(b), the units 6c of magnetic material are machined using a cutting tool 8 having a defined width. In addition, the ends of the cylindrical non-magnetic body 5 are similarly machined to remove the portions of the respective units 6c extending in the axial direction beyond the ends. During such machining, it is of no consequence whether respective portions of the non-magnetic body 5 (as a base material) also are machined away (FIG. 4(c)). In any event, as shown in FIG. 4(c), machining as described above produces a magnetic shield assembly comprising multiple units 6c of magnetic material each having a precisely defined width, with intervening gaps 9 of precisely defined axial width therebetween.

If the units 6c are made of a hard, brittle, amorphous magnetic material, then machining between them (FIG. 4(b)) can be performed by grinding rather than by cutting. Further alternatively, depending upon the specific magnetic material used to fabricate the units 6c, machining can be performed by electrical-discharge machining, laser machining or other suitable process instead of mechanical cutting or abrasion. These alternative techniques frequently can be performed without having any accompanying machining or erosion of the underlying non-magnetic body 5.

A representative embodiment of a CPB optical system including at least one electromagnetic lens as described above is shown schematically in FIG. 5. The system includes a CPB source 11, a first illumination lens 12a, a beam-shaping aperture 13, an aperture stop 14, and a second illumination lens 12b. A charged particle “illumination” beam produced by the source 11 propagates along an optical axis Ax to a reticle 15. The portion of the CPB optical system located between the source 11 and the reticle 15 is termed an “illumination-optical system.” The CPB optical system also includes a “projection-optical system” comprising first and second projection lenses 16a, 16b, respectively, and an aperture stop 17. The projection-optical system directs a “patterned beam” (produced by passage of the illumination beam through the reticle 15 which provides the patterned beam with an aerial image of the illuminated portion of the reticle 15) from the reticle to a suitable lithographic substrate 18 (e.g., a semiconductor wafer having an upstream-facing surface coated with a suitable “resist” so as to be imprintable with the aerial image).

The illumination lenses 12a, 12b ensure that the charged particle beam emitted from the source 11 uniformly illuminates the reticle 15. The projection lenses 16a, 16b form a focused image of the illuminated portion of the reticle 15 on the substrate 18. The aperture stops 14, 17 serve to block downstream propagation of off-axis scattered charged particles, thereby limiting the aperture angle of the respective beam. The beam-shaping aperture 13 is situated at an optically conjugate position with respect to the reticle 15, and controls the size of the illuminated region on the reticle 15 to a specified subfield size and profile.

Deflectors are not shown in FIG. 5. However, one or more of the illumination lenses 12a, 12b and projection lenses 16a, 16b can be configured as shown in FIG. 1(a), for example. Thus, ac magnetic fields produced by the respective deflectors associated with the lenses are prevented by the respective magnetic-shield bodies 6 from adversely affecting the respective electromagnetic lenses. Hence, stabilizations of the respective deflection magnetic fields can be performed rapidly, thereby allowing high-speed deflections and thus higher throughput.

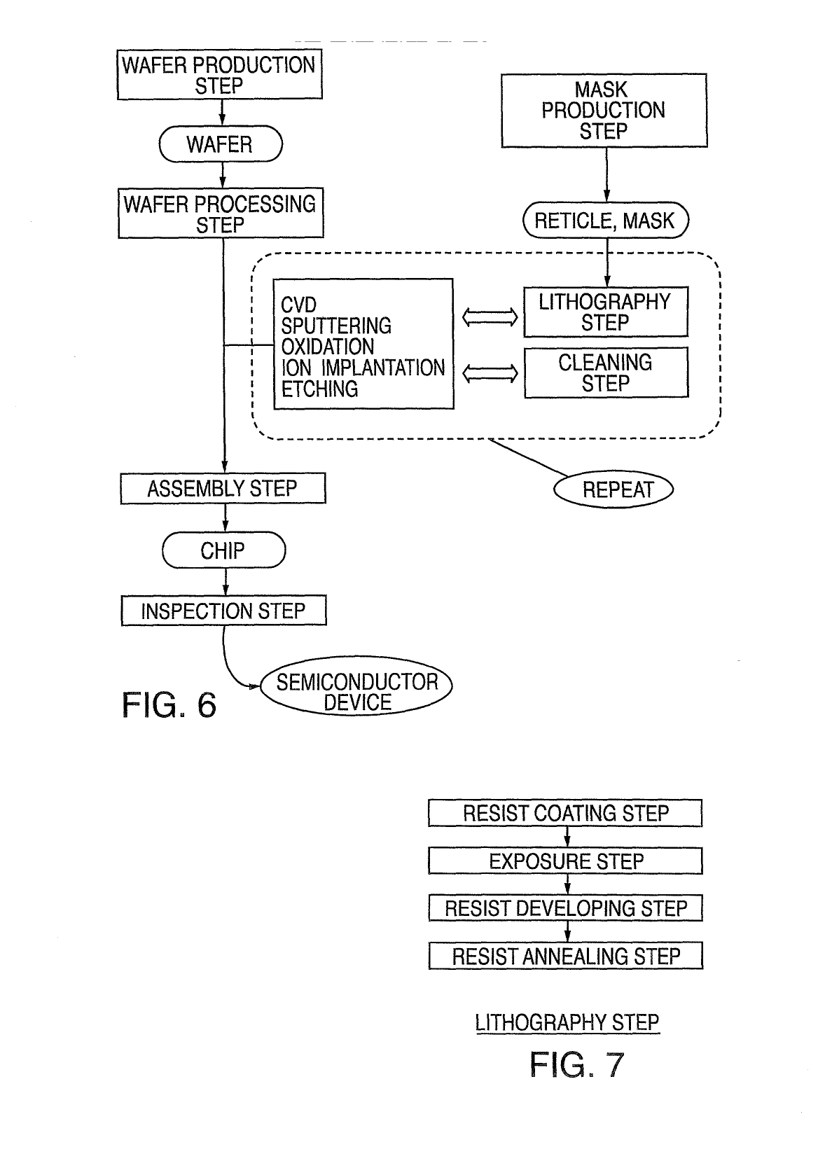

FIG. 6 is a flowchart of an exemplary microelectronic-device fabrication method to which systems and methods according to the invention can be applied readily. The fabrication method generally comprises the main steps of wafer production (wafer preparation), wafer processing, device assembly, and device inspection. Each step usually comprises several sub-steps.

Among the main steps, wafer processing is key to achieving the smallest feature sizes (critical dimensions) and best inter-layer registration. In the wafer-processing step, multiple circuit patterns are successively layered atop one another on the wafer, forming multiple chips destined to be memory chips or main processing units (MPUs), for example. The formation of each layer typically involves multiple sub-steps. Usually, many operative microelectronic devices are produced on each wafer.

Typical wafer-processing steps include: (1) thin-film formation (by, e.g., sputtering or CVD) involving formation of a dielectric layer for electrical insulation or a metal layer for connecting wires or electrodes; (2) oxidation step to oxidize the substrate or the thin-film layer previously formed; (3) microlithography to form a resist pattern for selective processing of the thin film or the substrate itself, (4) etching or analogous step (e.g., dry etching) to etch the thin film or substrate according to the resist pattern; (5) doping as required to implant ions or impurities into the thin film or substrate according to the resist pattern; (6) resist stripping to remove the remaining resist from the wafer; and (7) wafer inspection. Wafer processing is repeated as required (typically many times) to fabricate the desired semiconductor chips on the wafer.

FIG. 7 provides a flow chart of typical steps performed in microlithography, which is a principal step in wafer processing. The microlithography step typically includes: (1) resist-application step, wherein a suitable resist is coated on the wafer substrate (which can include a circuit element formed in a previous wafer-processing step); (2) exposure step, to expose the resist with the desired pattern; (3) development step, to develop the exposed resist to produce the imprinted image; and (4) optional resist-annealing step, to enhance the durability of the resist pattern.

The process steps summarized above are all well known and are not described further herein.

As explained above, the various embodiments described above, as well as other embodiments within the scope of the invention, solve the problems of conventional ferrite stacks in electromagnetic lenses, while also preventing magnetic fields (produced by a deflector, corrector, or dynamic-focus coil, for example) from reaching the electromagnetic lens. In addition, the subject electromagnetic lenses include magnetic-shield bodies that are easy to manufacture and that exhibit stable performance with respect to operating temperature and the like. The magnetic shielding in each such lens is rotationally symmetrical so as to avoid non-uniform effects.

Whereas the invention has been described in connection with representative embodiments, it will be understood that the invention is not limited to those embodiments. On the contrary, the invention is intended to encompass all alternatives, modifications, and equivalents as may be included within the spirit and scope of the invention, as defined by the appended claims.

What is claimed is:

1. An electromagnetic lens for use in a charged-particle-beam exposure apparatus, comprising along an optical axis:
a lens coil winding;
a pole piece associated with the coil winding;
at least one electromagnetic deflector situated concentrically with the coil winding and pole piece; and
a magnetic-shield body situated concentrically with the deflector, coil winding, and pole piece, the magnetic-shield body being configured as a magnetic metal foil situated between the deflector and the coil winding.

2. The lens of claim 1, wherein the electromagnetic deflector is selected from the group consisting of deflectors, correctors, and dynamic focus coils.

3. The lens of claim 1, wherein the magnetic-shield body has a cylindrical configuration that is concentric with the coil winding and pole piece.

4. The lens of claim 3, wherein the magnetic-shield body is attached to an outer cylindrical surface of a non-magnetic and electrically non-conductive body disposed between the magnetic-shield body and the deflector.

5. The lens of claim 4, wherein the magnetic-shield body is adhered to the outer cylindrical surface of the non-magnetic body.

6. The lens of claim 4, wherein the magnetic-shield body is wrapped multiple times circumferentially around the non-magnetic body, with an intervening layer of a thin non-conductive material situated between each resulting layer of the magnetic-shield body.

7. The lens of claim 4, wherein:
the pole piece includes a first axial end and a second axial end; and
the non-magnetic body is disposed so as to engage at least one of the axial ends of the pole piece.

8. The lens of claim 1, wherein:
the pole piece includes a first axial end and a second axial end; and
at least one of the first and second axial ends comprises ferrite.

9. The lens of claim 8, wherein:
the magnetic-shield body is attached to an outer cylindrical surface of a non-magnetic and electrically non-conductive body disposed between the magnetic-shield body and the deflector;
at least a respective portion of each of the first and second axial ends is made of ferrite; and
the non-magnetic body is situated, along the optical axis, between the first and second axial ends.

10. The lens of claim 1, wherein:
the pole piece includes a first axial end and a second axial end; and
the magnetic-shield body is situated, along the optical axis, between the first and second axial ends, with respective gaps between the magnetic-shield body and the first and second axial ends.

11. The lens of claim 1, wherein the magnetic-shield body comprises multiple portions separated from each other along the optical axis.

12. The lens of claim 1, wherein:
the magnetic-shield body is made of a material selected from a group consisting of Permalloy; alloys comprising at least one of iron, nickel, and cobalt; and amorphous materials comprising at least one of iron, nickel, and cobalt; and
the magnetic-shield body has a layer thickness of 10 to 30 μm.

13. A method for manufacturing a magnetic-shield body for use in an electromagnetic lens, comprising:
preparing a non-magnetic and electrically non-conductive body so as to have a cylindrical outer surface extending along an axis;
attaching multiple magnetic-shield body sheets circumferentially to the cylindrical outer surface, each body sheet having a sheet width, in an axial direction, that is wider than a specified sheet width, and the body sheets being separated from each other, in the axial direction, on the cylindrical outer surface by respective gaps that are narrower than a specified gap width; and
removing material along one or more circumferential edges of each respective magnetic-shield body sheet so as to widen the respective gaps to the specified gap width while narrowing each body sheet, in the axial direction, to the specified sheet width.

14. The method of claim 13, wherein the attaching step comprises adhering the body sheets to the cylindrical outer surface.

15. The method of claim 13, wherein the removing step comprises cutting the respective body sheets on the cylindrical outer surface.

16. The method of claim 13, wherein the removing step comprises grinding respective edges of the respective body sheets on the cylindrical outer surface.

17. A charged-particle-beam exposure apparatus, comprising an electromagnetic lens as recited in claim 1.

18. In a manufacturing method for a microelectronic device, a microlithography step performed using the charged-particle-beam exposure apparatus recited in claim 17.
